(19) United States
(12) Patent Application Publication
(10) Pub. No.: US 2018/0200944 A1
(43) Pub. Date: Jul. 19, 2018

(54) Apparatus and Method for Color Blending in 3D Printers

(71) Applicant: Felix Kwok Wai CHAN, San Po Kong, Kowloon (HK)

(72) Inventor: Felix Kwok Wai CHAN, San Po Kong, Kowloon (HK)

(21) Appl. No.: 15/576,979

(22) PCT Filed: Jun. 2, 2016
(86) PCT No.: PCT/CN2016/084483

§ 371 Date: Nov. 27, 2017

(30) Foreign Application Priority Data
Jun. 2, 2015 (HK) 15105248.2

(51) Int. Cl. B29C 64/112; B33Y 50/02

(52) U.S. Cl. CPC B29C 64/112; B33Y 30/00; B33Y 50/02

(57) ABSTRACT

Apparatus for blending colors for a three-dimensional object printer, includes a mixing chamber, a heating device connected to the mixing chamber for heating up the mixing chamber, and a guiding device including a plurality of color ingredient inlets. Each color ingredient inlet is adapted to receive a color ingredient for a single color. The guiding device is coupled to the mixing chamber such that the color ingredients are adapted to pass through the guiding device to enter the mixing chamber. The guiding device is configured to guide the color ingredients passing through the guiding device such that a vortex of the color ingredients is formed in the mixing chamber and exit via a mixed ingredient outlet. Also shown are a method and a 3D object printer. Effective color blending is provided in a single printing head achieving high definition color output capability by a relatively simple printing head structure.

### FIELD OF INVENTION

This invention relates to three-dimensional object printers, and in particular structures and working principles of printing heads in such printers.

### BACKGROUND OF INVENTION

Three dimensional (3D) object printing is one of the hottest new technology areas nowadays, which provides a brand new way of fabricating three dimensional objects based on computer 3D modeling or 3D scanning to a real object. Applications for 3D printing are found for example in artistic design, architecture, engineering and construction (AEC), automobile, aeronautics and astronautics, dental and medical industries, education, geographic information systems, civil engineering, and so on. As the 3D printing technology evolves rapidly, color 3D printing is also now possible for printing a 3D object with different colors applied to different parts of the object.

However, traditional desktop color 3D printers have various drawbacks that impede users from obtaining a resulting object in the exact appearance as they would expect. For example, due to limitations in the printers, there are often an insufficient number of colors exposed in the printed object. One type of the conventional color 3D printers for instance uses multiple printing heads with each printing head responsible for a single base color. However, this kind of color printing not only requires a complicated multiple printing head system demanding substantial cost and system complexity, but also the outcome color is depended on the material color. Such printing technique would not be sufficient to provide the vast spectrum of colors that are widely used in the computer designs and can be shown by almost all modern display devices.

### SUMMARY OF INVENTION

In the light of the foregoing background, it is a target of the present invention to provide an alternate color blending apparatus for a 3D printer so that an accurate proportion of separate colors can be mixed to generate the desired output color for dots in the object.

The above object is met by the combination of features of the main claim; the sub-claims disclose further advantageous embodiments of the invention.

The present invention provides, in one aspect, an apparatus for blending colors for a three-dimensional object printer, which includes a mixing chamber including a mixed ingredient outlet, a heating device connected to the mixing chamber for heating up the mixing chamber; and a guiding device including a plurality of color ingredient inlets. Each the color ingredient inlet is adapted or configured to receive a color ingredient for a single color. The guiding device is coupled to the mixing chamber such that the color ingredients are adapted or configured to pass through the guiding device to enter the mixing chamber. The guiding device is configured to guide the color ingredients passing through the guiding device such that a vortex of the color ingredients is formed in the mixing chamber.

Preferably, the color ingredient is a thread material. The guiding device further includes a plurality of channels each for one color ingredient to pass through. The channels guide the color ingredients to form a predetermined angle between at least two of the color ingredients.

More preferably, the channels are configured in the guiding device in a way to form an acute angle with a longitudinal axis of said mixing chamber.

In one implementation, the acute angle is in the range of 2° to 10°.

In a most preferred implementation, the acute angle is 5°.

In one variation of the present invention, the mixing chamber further contains a first cylindrical chamber and a second cylindrical chamber. The first cylindrical chamber has a diameter larger than that of the second cylindrical chamber. The second cylindrical chamber is connected to the mixed ingredient outlet. The first cylindrical chamber is adapted to receive the guided color ingredients from the guiding device.

Preferably, the first cylindrical chamber is adapted to receive at least a portion of the guiding device.

Preferably, the first cylindrical chamber and second cylindrical chamber are connected by an intermediate portion having a truncated cone shape.

According to an exemplary embodiment, the mixing chamber and the guiding device are connected by a plurality of fasteners.

Preferably, the guiding device further contains a first end face where the plurality of color ingredient inlets are disposed, and a second end face facing the mixing chamber. The fasteners extend from the first end face to pass through the guiding device, and exit the second end face to connect to the mixing chamber, thus connecting the guiding device and the mixing chamber together.

More preferably, there is at least one spring placed between the mixing device and the second end face of the guiding device.

In one specific implementation, there are a plurality of coil springs placed between the mixing device and the second end face of the guiding device, and each coil spring receives and allows one the fastener to pass therethrough.

Preferably, the fasteners are screws.

In one variation of the present invention, wherein the heating device further contains a thermometer for detecting real-time temperature of the mixing chamber.

In another variation of the present invention, the color ingredients are fusible color filaments.

Preferably, the guiding device contains four color ingredient inlets, each of which corresponding to a color in the CMYK (cyan, magenta, yellow, and key (black or white)) color model.

In a further variation of the present invention, the heating device controls temperature of the mixing chamber from 160° C. to 240° C.

In a further variation of the present invention, the mixing chamber has an interior volume in the range of 100 mm³ to 300 mm³.

Preferably, the mixing chamber has an interior volume of 160 mm³.

In a further variation of the present invention, the apparatus further includes a nozzle connected to the mixed ingredient outlet by thread connection.

According to another aspect of the present invention, a three dimensional object printer contains a color ingredient feeding device, a printing head containing a color blending apparatus as described above, and a printing head driving module.

According to another aspect of the present invention, a method for blending colors for a three dimensional object printer, comprises feeding a plurality of color ingredients into a guiding device, guiding said plurality of color ingredients by the guiding device to enter a mixing chamber, heating the mixing chamber to a predetermined temperature, and blending the plurality of color ingredients in the mixing device. During the guiding, the color ingredients are guided in such a way that after they pass through the guiding device and enter the mixing chamber, a vortex of the color ingredients is formed in the mixing chamber.

Preferably, the color ingredient is a thread material. The guiding device further includes a plurality of channels each for one of the color ingredient to pass through. The guiding step further includes guiding the color ingredients via the channels to form a predetermined angle between at least two of the color ingredients.

More preferably, the channels are configured in the guiding device in a way to form an acute angle with a longitudinal axis of said mixing chamber.

In one implementation, the acute angle is in the range of 4° to 20°.

In a most preferred implementation, the acute angle is 10°.

In one variation of the present invention, the mixing chamber further contains a first cylindrical chamber and a second cylindrical chamber. The first cylindrical chamber has a diameter larger than that of the second cylindrical chamber. The second cylindrical portion is connected to the mixed ingredient outlet. The first cylindrical portion is adapted to receive the guided color ingredients from the guiding device.

Preferably, the first cylindrical chamber is adapted to receive at least a portion of the guiding device.

Preferably, the first cylindrical chamber and second cylindrical chamber are connected by an intermediate portion having a truncated cone shape.

According to an exemplary embodiment, the mixing chamber and the guiding device are connected by a plurality of fasteners.

Preferably, the guiding device further contains a first end face where the plurality of color ingredient inlets are disposed, and a second end face facing the mixing chamber. The fasteners extend from the first end face to pass through the guiding device, and exit the second end face to connect to the mixing chamber, thus connecting the guiding device and the mixing chamber together.

More preferably, there are at least one spring placed between the mixing device and the second end face of the guiding device.

In one specific implementation, there are a plurality of coil springs placed between the mixing device and the second end face of the guiding device, and each coil spring receives and allows one the fastener to pass therethrough.

Preferably, the fasteners are screws.

In one variation of the present invention, the method includes heating the mixing chamber by a heating device which contains a thermometer for detecting real-time temperature of the mixing chamber.

In another variation of the present invention, the color ingredients are fusible color filaments.

Preferably, the guiding device contains four color ingredient inlets, each of which corresponding to a color in CMYK color model.

In a further variation of the present invention, the mixing chamber is heated to a predetermined temperature which is in the range of 160° C. to 240° C.

Preferably, the mixing chamber is heated to a predetermined temperature which is 175° C. or 230° C.

In a further variation of the present invention, the mixing chamber has an interior volume in the range of 100 mm³ to 300 mm³.

Preferably, the mixing chamber has an interior volume of 160 mm³.

In a further variation of the present invention, a nozzle is connected to the mixed ingredient outlet of the mixing chamber by thread connection.

In a further variation of the present invention, an inner surface of the mixing chamber is coated with a non-sticking material.

Preferably, the non-sticking material is PTFE.

There are many advantages to the present invention, the most apparent one being that the present invention achieves a single printing head color printing with a vast spectrum of colors available in the printed object. By utilizing the color blending apparatus in the printing head, theoretically any color that can be represented using a CMYK model can be printed out. The 3D object therefore preserves a high fidelity of colors as compared to what are originally present in the 3D computer design model in the computer.

The color blending apparatus and method according to the present invention also operate in an automatic way. The user does not have to interfere with the printing process after a printing instruction is made from the computer to the printer. The only thing that the user needs to check is that there is sufficient volume of color filaments ready to be fed into the printer. Other than that, the four basic color filaments are automatically fed into the printing head by the required proportions in order to mix the desired color. The printing head then prints out one or more dots of the object using the mixed color. Upon the printing head finishing printing one color and about to change to print another color, the color ingredient feeders automatically starts feed new proportions needed for the new color to the printing head. The new color is then mixed and the next printing operation starts. The printing process using a 3D color printer in the present invention is therefore a carefree process to the user.

### BRIEF DESCRIPTION OF FIGURES

The foregoing and further features of the present invention will be apparent from the following description of preferred embodiments which are provided by way of example only in connection with the accompanying figures, of which:

FIG. 1 is a perspective view of a 3D object printer according to a first embodiment of the present invention, with a detailed view of the X-Y connector for the printing head in the printer.

FIG. 2 is a perspective view of the X-Y connector alone which is used in the printer in FIG. 1.

FIG. 3 shows the printer in FIG. 1 from its top.

FIG. 4 shows the printer in FIG. 1 viewing a side of the casing on which the color ingredient feeders are configured.

FIG. 5 is a transparent view of the printer in FIG. 1.

FIG. 6 illustrates the perspective view of a printing head of a 3D object printer according to one embodiment of the present invention.

FIG. 7 shows the side view of the printing head in FIG. 6.

FIG. 8 illustrates the perspective view of the printing head in FIG. 6 from another orientation.

FIG. 9 shows a front, transparent view of the printing head in FIG. 6.

FIG. 10 illustrates the perspective view of the color blending apparatus in the printing head of FIG. 6.

FIG. 11 illustrates the exploded, perspective view of the color blending apparatus in the printing head of FIG. 6.

FIG. 12 is the side exploded view of the color blending apparatus in the printing head of FIG. 6.

FIG. 13 shows the color ingredient feeder of a 3D object printer according to one embodiment of the present invention.

FIG. 14 is the top view of the color ingredient feeder of FIG. 13.

FIG. 15 is a side view of the color ingredient feeder of FIG. 13 when it is loaded with a color ingredient ready for feeding.

### DETAILED DESCRIPTION OF THE PREFERRED EMBODIMENTS

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated.

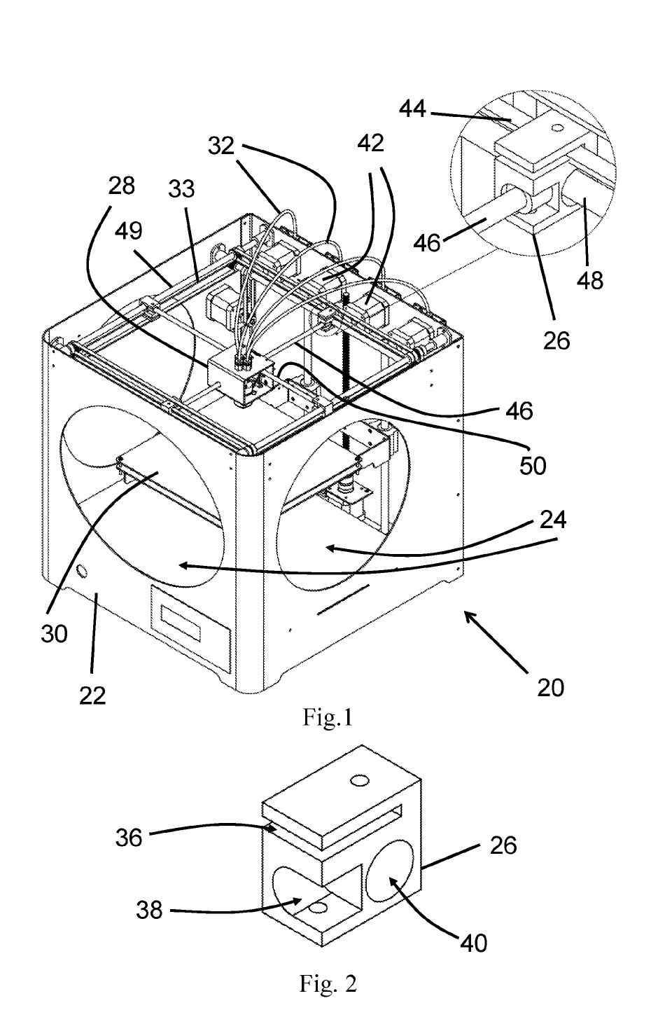

Referring now to FIGS. 1 and 3-5, the first embodiment of the present invention is a three-dimensional object printer 20 which is equipped with a color blending apparatus, so that a vast spectrum of colors may be outputted by the printer in a high color resolution. The printer 20 contains a casing 22 substantially in a cubic box shape, but with an open top. On one or more sides of the casing 22 there are also removed parts which are used as observing windows 24 for the user to observe the printing progress of the object during printing operation. Inside the casing 22, a movable object table 30 is configured. The space right above the object table 30 is the printing zone, although the object table 30 moves as the printing process goes on. A printing head 28 capable of moving in two orthogonal directions in the printing zone is “hung” by two head support rod 46, 50 in the printing zone at a location adjacent to the open top of the casing 22. On top of the printing head 28 there are connected four filament tubes 32 through which fusible filaments (not shown) in different base colors are fed by four color ingredient feeders 42 which are mounted on a sidewall of the casing 22. The fusible filaments are thread shaped materials, and are used as color ingredients for the 3D printer 20 described above. In the printer 20 four filaments are used, each in one of the base colors as defined in CMYK color model, that are cyan, magenta, yellow or key (black or white).

Also shown in FIG. 1 is an enlarged view of the X-Y connector 26 which functions to allow the printing head 26 moving in one of the two orthogonal directions while remaining still in the other one of the two orthogonal directions. The two orthogonal directions along which the printing head 28 can move are defined as X and Y directions of the printer 20, and both of which are parallel to the plane defined by the object table 30. Among the two orthogonal directions, the X direction and the Y direction can be chosen arbitrarily, but for the sake of discussion here assume that axis which extends along the sidewall of the casing 22 on which the color ingredient feeders 42 are mounted is the Y axis. Consequently, in FIG. 1 the Y-axis rail 48 is a rail along which the X-Y connector 26 can move along the Y axis. The X-axis rail 49 shown in FIG. 1 is parallel to the head support rod 46.

The following descriptions about the X-Y connector are made by using the X-Y connector 26 coupled to the Y-axis rail 48 as an example. As shown in FIGS. 1 and 2, the X-Y connector 26 contains a through hole 40 to allow a rail like the Y-axis rail 48 in FIG. 1 to pass through. The X-Y connector 26 can freely move along the Y-axis rail 48 in the Y-axis. In the X-Y connector 26 there is also a lock hole 38 for locating and locking an end of a head support rod 46, so that when the X-Y connector 26 moves relative to the Y-axis rail 48 the head support rod 46 also moves laterally along the Y axis, despite that the support rod 46 itself has a length along the X axis. The Y-axis rail 48 is shown to be a rod-like rail, as the Y-axis rail 48 also functions to transmit the rotational power from the X-axis stepping motor (not shown) to the corresponding X-axis horizontal belt 33. In other words, the Y-axis rail 48 does not serve to transmit driving force to the Y-axis horizontal belt 44 parallel to the Y-axis rail 48, but instead transmits driving force to the X-axis horizontal belt 33 movable along an orthogonal direction to the Y-axis rail 48. The rotation of the Y-axis rail 48 does not affect the X-Y connector 26 coupled thereto since there is a slipping-fit between them. Lastly, the X-Y connector 26 further contains a through slit 36 through which a Y-axis horizontal belt 44 passes to reside therein as shown in the enlarged view of the X-Y connector 26 of FIG. 1. The Y-axis horizontal belt 44 is coupled to a stepping motor which could be activated to drive the Y-axis horizontal belt 44. Preferably, on the surface of the Y-axis horizontal belt 44 and on the inner surfaces of the through slit 36 there are formed geometrical features such as teeth, which enable the Y-axis horizontal belt 44 to securely engage with the X-Y connector 26, such that any movement of the Y-axis horizontal belt 44 results in X-Y connector 26 moving at the same time.

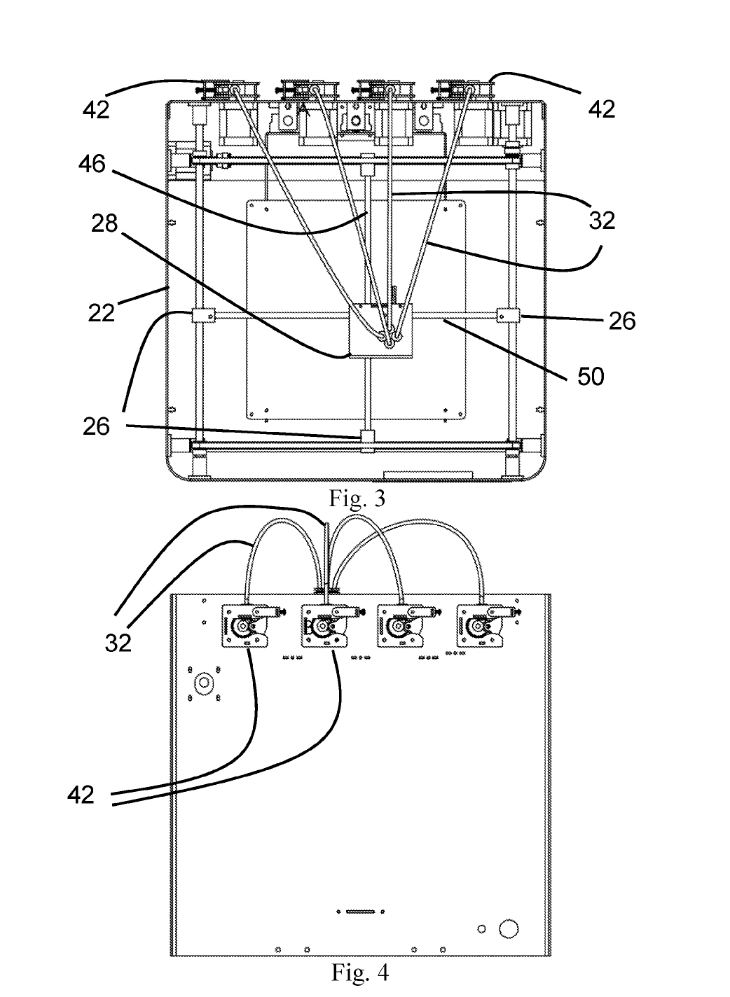

Although in FIG. 1 and FIG. 2 the X-Y connector 26 is shown with an orientation to engage with the Y-axis horizontal belt 44 which is placed in parallel and above the rail 48, this is not the only possible configuration. For other X-Y connectors (FIG. 3 shows four such X-Y connectors) used in the printer 20, their orientations may be opposite to the one shown in FIGS. 1 and 2 as necessary, i.e. the rail passing through the X-Y connector is located above the belt. This is in particular needed due to space constraints in the printing head driving mechanism, where the horizontal belts for X and Y directions should not be made at the same vertical level, and the rails for X and Y directions also should not be made at the same vertical level.

The top view of the printer shown in FIG. 3 illustrates how the printing head 28 is mounted. In particular, as mentioned above there are in total four X-Y connectors 26 in the printer. The one near the color ingredient feeders 42 was used as an example above to explain its structure and shape. As shown in FIG. 3, for each moving direction (i.e. X or Y) of the printing head 28 there is a parallel pair of a rail and belt structure. That is, each one of the two head support rods 46 and 50 that are arranged in a cross shape to support the printing head 28 is supported on rails configured in parallel that extend adjacent to and along two opposite sidewalls of the casing 22 and perpendicular to the respective support rod. Preferably, there are also set of horizontal belts configured in parallel and each is made adjacent to one of the parallel rails so that for every one of the four X-Y connectors in the printer, there is a set of rail and belt for each of the X and Y directions. For easy discussion as regards this embodiment, the head support rod 46 refers to the rod which is parallel to the X axis, and head support rod 50 refers to the rod which is parallel to the Y axis in FIGS. 1-5. By utilizing two parallel horizontal belts at the opposite ends of the head support rod 46 or 50, the head support rod can be driven with balance on its two ends, therefore ensuring that head support rod and in turn the printing head is moved to a precise coordinate.

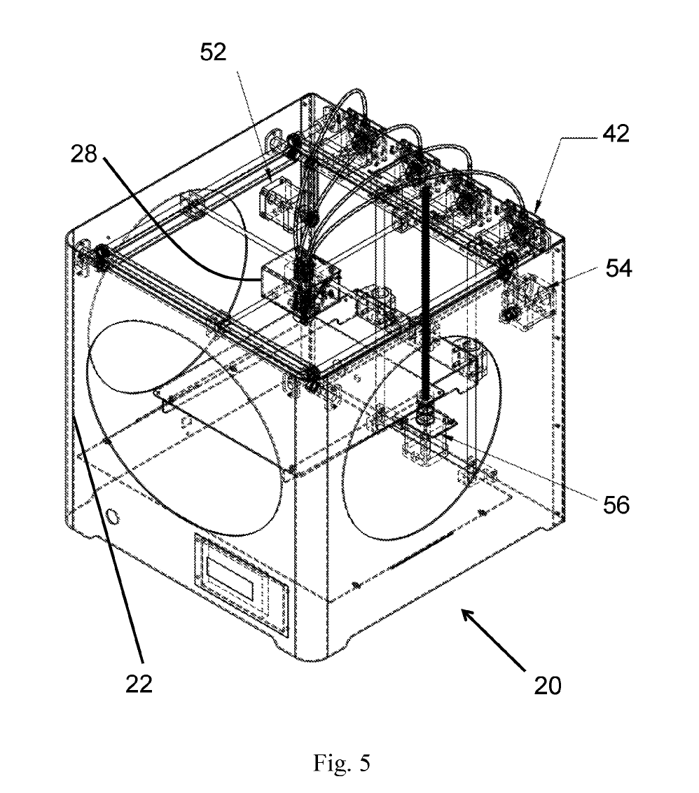

Referring now to FIG. 5, the driving means for the three dimensional printing are shown in the printer 20. In particular, an X-axis stepping motor 52 is mounted on a sidewall of the casing 22 facing the X-axis rail and X-axis horizontal belt. A Y-axis stepping motor 54 similarly is configured on another sidewall of the casing 22 facing the Y-axis rail and Y-axis horizontal belt. The X-axis and Y-axis stepping motors drive the horizontal belts via one or more vertical belts (not shown). In particular, taking the X-axis stepping motor as an example, the output shaft of the motor is drivingly connected to the Y-axis rail by a vertical belt. The Y-axis rail is then drivingly connected to the X-axis horizontal belt. As mentioned previously the Y-axis rail, although serving as a support for the X-Y connector along the Y-axis, simultaneously functions to transmit driving power from the X-axis stepping motor to the X-axis horizontal belt. This is because the rotation of the Y-axis rail does not affect the X-Y connector along the Y-axis due to the slipping-fit between them. Preferably, for the motor output shaft, rails, and horizontal and vertical belts, their contacting surfaces are formed with uneven teeth to increase the friction and also to ensure every one of them moves at a predetermined pace identical to the pace of the stepping motor.

In the printer, there is also a Z-axis stepping motor 56, which does not function to move the printing head 28 but instead the object table 30. The Z-axis stepping motor 56 uses a rack mechanism to move the object table 30 along the vertical direction (i.e. Z axis), rather than belts as for the other two directions. This is because to move the object table 30 on which the object to be printed/in printing is placed, a large motor torque is required and thus the belt mechanism would be not as stable and accurate as the rack mechanism in transmitting the torque.

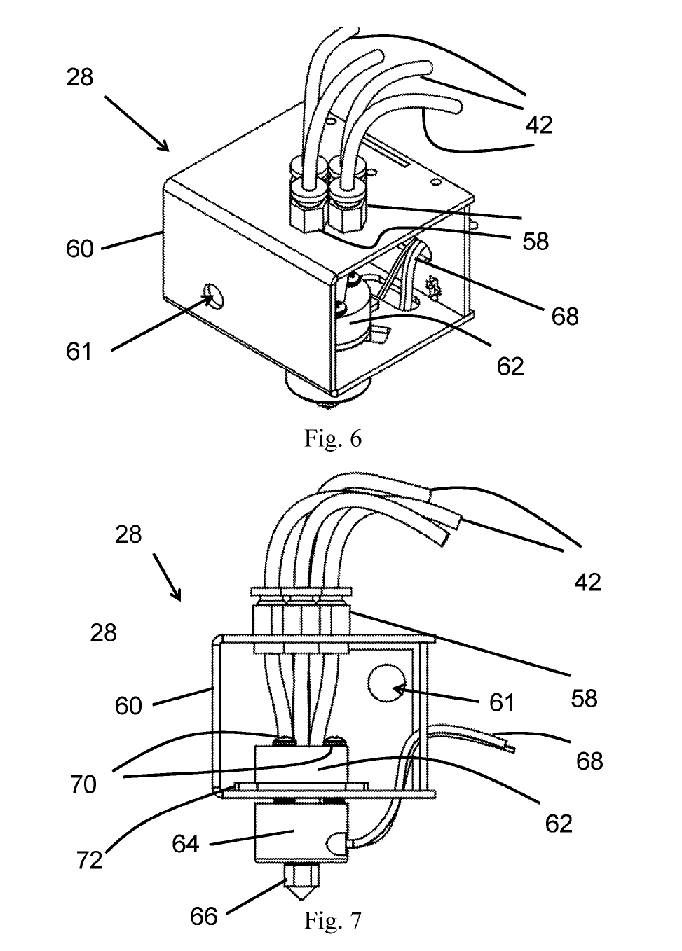

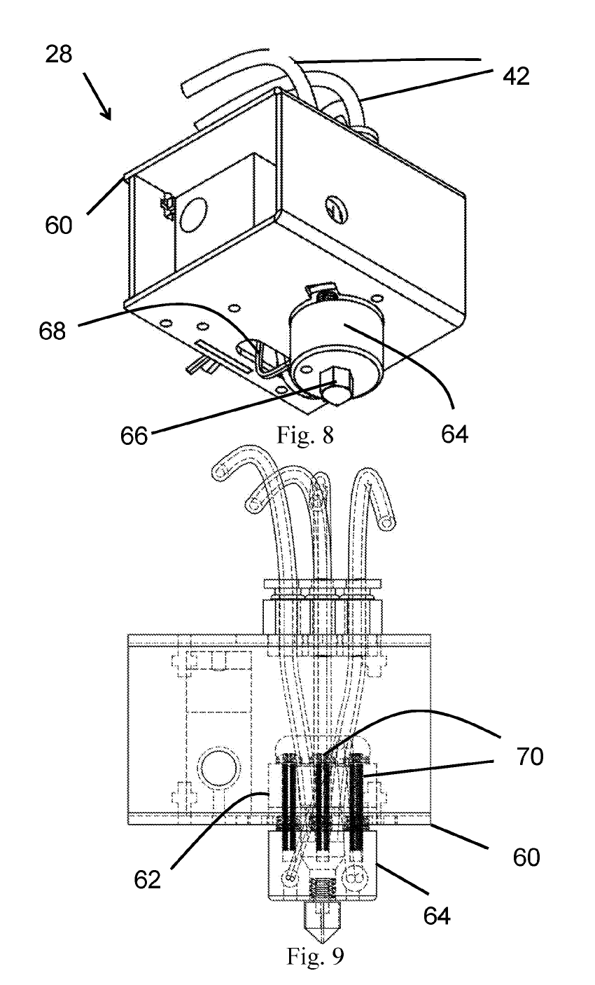

Referring now to FIGS. 6-9, the printing head 28 used in the 3D printer in the present invention is now described. The printing head 28 includes a head casing 60, in the inner space of which major components of the printing head 28 are accommodated. The head casing 60 is not fully closed, but at least a side of it is left open. On the three sidewalls of the head casing 60, there are formed perforations 61 which are used to allow the head support rods described above to pass through, therefore supporting the printing head 28. On the top face of the head casing 60, the four color ingredient tubes 42 are connected to the printing head 28 by securing the color ingredient tubes 42 to the head casing 60 by nuts 58. The color ingredient tubes 42 penetrate the top face of the head casing 60, and continue to extend until they connect to and terminate at the guiding device 62. Preferably, the four nuts 58 on the top face of the head casing 60 are aligned to form a square footprint on the top face, therefore concentrating the color filaments in a small area. The square shape alignment of the color ingredient tubes 42 also helps to prepare for the color blending process, which will be described in more detail below.

The guiding device 62 is located within the head casing 60, and the guiding device 62 is fixed to a head body 64 by a plurality of screws 70. The screws 70 have their head portions secured to the top face of the guiding device 62 and extend to pass through, in turn, the guiding device 62, a mounting plate 72, the bottom part of the head casing 60, and finally enter a portion of the head body 64. The screws 70 therefore affix the guiding device 62 and the head body 64 to the bottom part of the head casing 60. The guiding device 62 is supported on the bottom part of the head casing 60 by the mounting plate 72. A pair of heater and a thermistor wires 68 are shown extending through the sidewall of the head casing 60 to connect the head body 64 to a controller of the printer (not shown), so that control commands for controlling the head body temperature are sent to the printing head 28 from the controller. At the bottom of the head body 64, there is a nozzle 66 for ejecting mixed color ingredients (i.e. fused and mixed color filaments) out of the printing head 28 to print the 3D object.

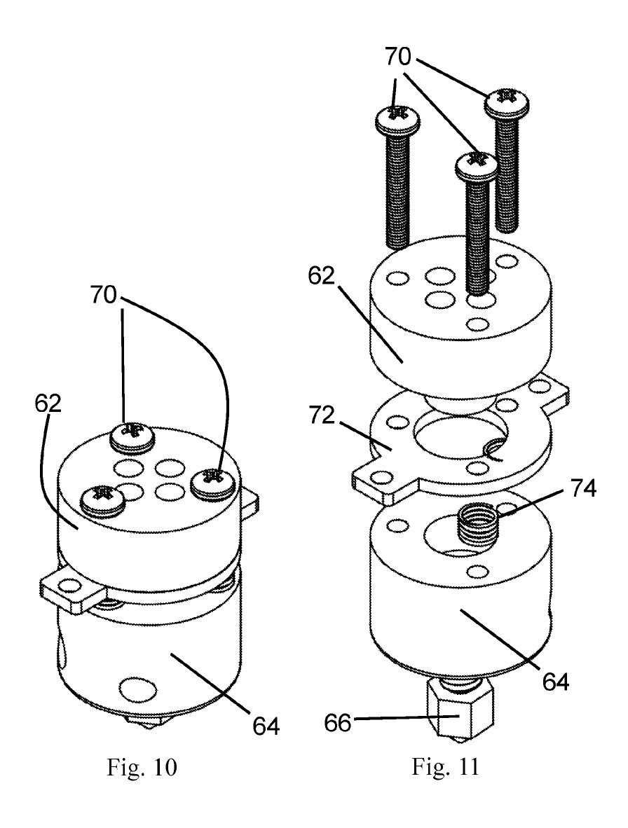

Turning to FIGS. 10 and 11, which show the guiding device 62, the mounting plate 72, and the head body 64 separated from other components of the printing head. The three screws 70 are arranged symmetrically around a center axis of the guiding device 62, the mounting plate 72, and the head body 64. There are also three coil springs 74 placed between the mounting plate 72 and the head body 64, each receiving and allowing one of the three screws 70 to pass therethrough. The mounting plate 72 further contains a central bore. The central bore is used for a lower portion 85 of the guiding device 62 to pass through.

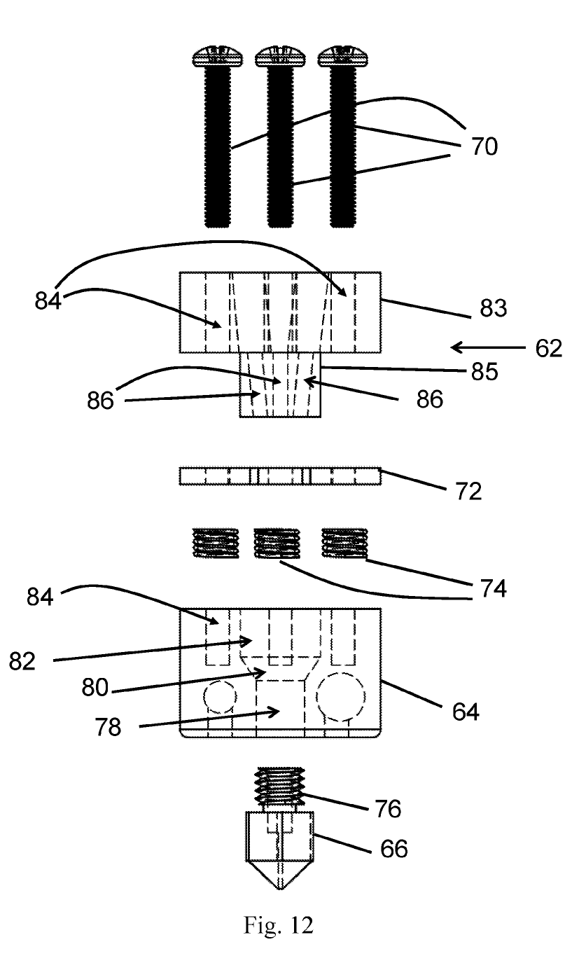

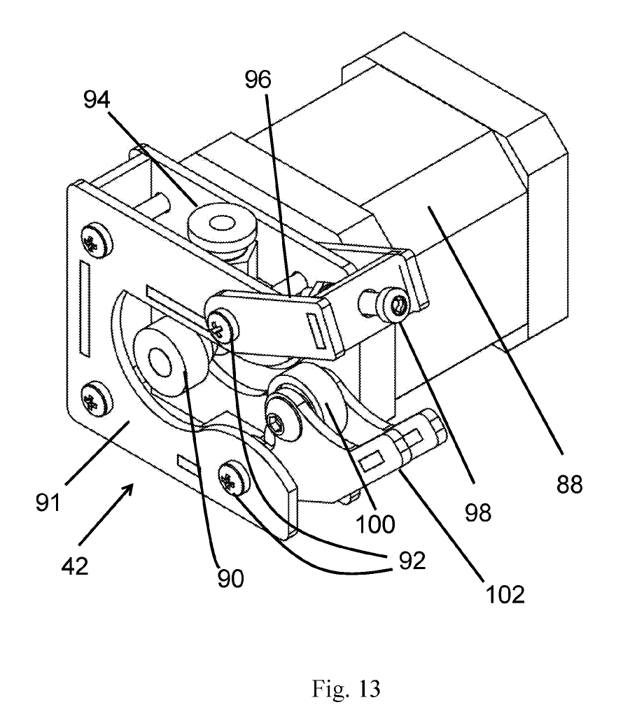

The upper portion 83 and the lower portion 85 of the guiding device 62 are clearly illustrated in FIG. 12. The upper portion 83 and the lower portion 85 both have cylindrical shapes and are arranged concentrically. However, the upper portion 83 has a diameter larger than that of the lower portion 85. The upper portion 83 has screw holes 84 formed therein, so that the screws 70 could pass through the upper portion 83 and secure the guiding device 62 to other components. Note that the screws 70 do not penetrate the lower portion 85 but rather are arranged outside the lower portion 85 after assembly. In both the upper portion 83 and the lower portion 85, there are channels 86 formed to allow color filaments to pass through. Each channel 86 corresponds to one color filament. Preferably, the color ingredient tubes described previously terminate in the upper portion 83, but the color filaments contained in the color ingredient tubes continue to extend to the lower portion 85. The lower portion 85 is adapted to pass through the central bore of the mounting plate 72 in FIG. 11, a corresponding bore on the bottom part of the head casing (not shown), and at least partially received in the head body 64.

In the above embodiment, notably the channels 86 are not made parallel to each other. Rather, the channels 86 are aligned to form an acute angle between each two adjacent channels 86. The four channels 86 therefore appear to converge to a point if viewed from the top of the guiding device 62 downwards. The inclined channels 86 relative to the horizontal direction in FIG. 12 force the color filaments to also form the same acute angle between each two adjacent ones. The angle between each channel 86 and the vertical axis (Z axis) is in the range of 2° to 10°, and preferably 5°.

Now looking at the head body 64, which includes a mixing chamber that includes three parts. The first portion 82 is a cylindrical chamber adapted to receive the lower portion 85 of the guiding device 62 from the above. The second portion 78 is also a cylindrical chamber which leads to an exit of the mixing chamber, which is also referred to as a mixed ingredient outlet. However, the inner diameter of the first portion 82 is larger than that of the second portion 78. Between the first portion 82 and the second portion 78 there is an intermediate portion 80 which has a truncated cone shape. The mixing chamber has an effective interior volume in the range of 100 mm³ to 300 mm³, and preferably 160 mm³. The second portion 78 further contains threads on its inner circumferential surface so that the nozzle 66, which has an upper part 76 configured with exterior threads, can be fastened to the exit of the mixing chamber. There are screw holes 84 in the head body 64 to receive the tail ends of the screws 70.

Preferably, the inner surface of the mixing chamber which is designed to be in contact with the fused filament is coated with a layer of non-stick coating. For example, the non-stick coating is made of Polytetrafluoroethylene (PTFE) material. The function of the non-stick coating is to decrease the friction between the fused filament and the chamber surface. The non-stick coating also reduces the chance that the fused filament will stick on the inner surface of the mixing chamber, which improves significantly the extrusion of filament.

The head body 64 is also connected to a heating device (not shown) to heat up the mixing chamber so that the temperature inside the mixing chamber reaches a desired level. The heating device is controlled by the controller of the printer, and preferably there is a thermometer connected to the mixing chamber to send a feedback signal in real time indicative of the chamber temperature to the controller. The head body 64 and the nozzle 66 are preferably made of brass or aluminum to tolerate the high temperature of the fused filaments.

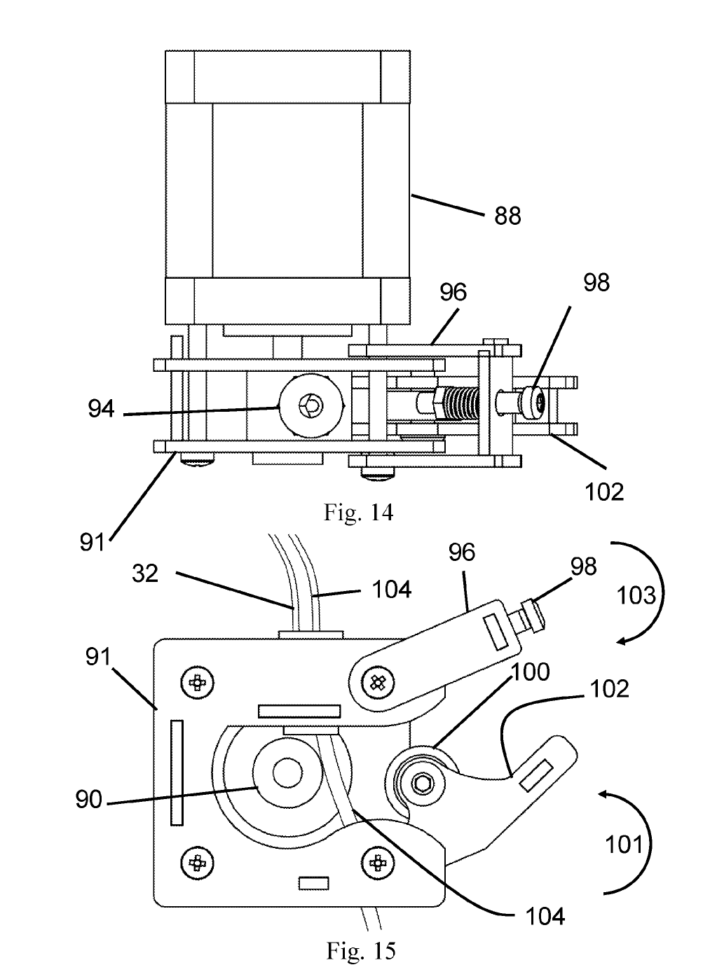

FIGS. 13-15 show one of the color ingredient feeders 42 according to embodiments of the present invention. As mentioned above the color ingredients are in one implementation color filaments. The color ingredient feeders are configured to feed the color filament at a precise amount to the printing head 28 for mixing the desired color, which will be described in more detail below. The color ingredient feeder 42 shown in FIGS. 13-15 includes a stepping motor 88 of which the output shaft (not shown) is affixed with a driving wheel 90. End plates 91 with a substantially “U” shape are placed surrounding the driving wheel 90. As shown in the figures there are two end plates 91 parallel to each other but separated by a distance. The end plates 91 are fixed to one end of the stepping motor 88 by screws. Opposite to the driving wheel 90 is an idle wheel 100 which is rotatably mounted on a wheel support 102. Above the driving wheel 90 and the idle wheel 100 there is a tube connector 94 for connecting the color ingredient tubes described above, so as to feed the color filament to the printing head via the color ingredient tubes. In the color ingredient feeder 42 there is also an adjustment support 96 on the outer end of which there is an adjusting screw 98. The adjusting screw 98 can be rotated to adjust its depth into the adjustment support 96. Both the adjustment support 96 and the wheel support 102 are pivotally mounted on the end plates 91 by screws 92. Preferably, the driving wheel 90 has teeth formed on its circumference to increase friction between the filament and the driving wheel 90, and also to more accurately control the pace of the filament for each motor step.

Now turning to the operation of the device described above. During the printing process of a 3D design when the 3D printer is connected to a computing device such as a desktop computer, notebook or tablet, the computing device sends commands to the printer on a dot-by-dot basis. That is, the spatial coordinates of each dot in the 3D object to be printed (i.e. X, Y and Z coordinates), and the required color of the dot, are sent to the printer as commands. As mentioned above the printer contains a controller for receiving the print instructions from the computing device and converting it to the specific controlling signals for various components in the printer, including the stepping motors and the printing head.

The four color filaments representing the four base colors of a CMYK color model, i.e. cyan, magenta, yellow, and key (black or white), are first fed into the printer through the plurality of color ingredient feeders 42 in FIGS. 1-5 as shown in detail by the feeder 42 in FIGS. 13-15. FIG. 15 shows how the filament is inserted into a color ingredient feeder and fed by the feeder to the printing head. The filament 104 is inserted from the bottom of the color ingredient feeder 42 upward, and passes through the space between the two end plates 91 described above. The filament 104 is then inserted into the tube connector 94 and enters the color ingredient tubes 32 leading to the printing head. However, the filament 104 must be engaged between the driving wheel 90 and the idle wheel 100 in order for the stepping motor 88 to exert driving force to the filament 104. This engagement is achieved by pressing the filament 104 against the driving wheel 90, and then rotates the wheel support 102 from the position shown in FIG. 15 counterclockwise along the direction shown by arrow 101, thus making the idle wheel 100 contacting the filament 104. The filament 104 is then limited between the driving wheel 90 and the idle wheel 100 and is ready to be driven toward the printing head. However, in order to ensure that a proper pressure is produced between the driving wheel 90 and the filament 104, after the wheel rack 102 is rotated to make the idle wheel 100 contact the filament 104, the user then rotates the adjustment support 96 in the clockwise direction in FIG. 15 which is indicated by arrow 103. The end of the adjustment support 96 then is engaged with the end of the wheel support 102, and the adjusting screw 98 has a tail end (not shown) pressing against the wheel support 102. To adjust the pressure between the driving wheel 90 and the filament 104, the user simply rotates the head end of the adjusting screw 98 to change its depth along the longitudinal direction of the adjustment support 96. As a result, as the adjusting screw 98 presses against the wheel support 102 it is pushed further to the driving wheel 90 and creates more pressure between the driving wheel 90 and the filament 104, or vice versa. To unload a filament from the color ingredient feeder, one just needs to follow exactly the reversed procedures as described above to separate the filament from the color ingredient feeder.

After all the required filaments are fed into the printer, the printer can then start the printing job according to received instructions from the computing device. The controller in the printer functions to convert the printing instructions to lower level commands to the motors. For example, for a dot in the object with a specific color, color mixing commands are sent by the controller to the four stepping motors in the four color ingredient feeders to conduct color mixing or blending. This is achieved by the controller calculating the proportions of the four base colors in the CMYK color system to yield the desired color. For example, to print a dot with a coffee color, the proportions of the four colors are: 0% cyan, 29.7% magenta, 50.5% yellow and 56.5% black (key). The required amount of filament for each base color is then fed into the printing head by the controller sending motor control commands to the four stepping motors in the four color ingredient feeders. For color ingredients that are of smaller proportions, the corresponding stepping motors rotates for less steps, and for color ingredients that are of larger proportions, the corresponding stepping motors rotates for more steps. By controlling the stepping motors in this way, a predetermined amount (length) of the filaments can be fed into the printing head.

The filaments fed into the printing head 28 are then fused and mixed by the color blending apparatus described above. Referring to FIG. 12, the color filaments enter the guiding device 62 through the color ingredient inlets which are formed on the top of the guiding device 62. The channels 86 in FIG. 12 then align the filaments so that they form acute angles between each other. As mentioned above the angle between each channel 86 and the vertical axis (Z axis) is in the range of 2° to 10°, and preferably 5°. The channels 86 forcing the filaments entering the mixing chamber to have the same angle with the channels 86. Note that during the above processes the filaments are driven to move forward all because of the stepping motors in the color ingredient feeders.

When the printer is in operation, the mixing chamber is heated to a predetermined temperature as mentioned above so as to effectively fuse the solid filaments. Preferably, the temperature inside the mixing chamber is 175° C. for Polylactic Acid (PLA) filaments, or 230° C. for Acrylonitrile Butadiene Styrene (ABS) filaments. As the filaments enters the first portion 82 of the mixing chamber at predetermined angles, and at the same time are fused into liquids, there is a vortex effect created in the mixing chamber such that the filaments are completely and uniformly mixed, producing the desired color of the dot according to the printing instructions.

After the required color is mixed in the mixing chamber, or at the same time of mixing the color, the printing head 28 is also moved to the designated X-Y coordinates according to the printing instructions. Due to the presence of the X-Y connectors, the X-axis stepping motor and the Y-axis stepping motor each rotates to move the printing head 28 to the desired X and Y axis coordinates. The X-axis movement and the Y-axis movement of the printing head 28 are independent, and can be done simultaneously. This is because the X-Y connectors are slipping-fit to their corresponding rails, and one X-Y connector's movement along one of the X and Y directions does not affect another X-Y connector movable along the other one of the X and Y directions. The controller sends instructions to each one of the X-axis stepping motor and the Y-axis stepping motor and they rotate simultaneously to move the printing head to the desired location in the X-Y plane.

On the other hand, the Z-direction movement is independent from the X and Y direction movements. The 3D object on the object table is printed on a layer-by-layer basis, and each layer is defined as a plane along the Z axis. In other words, for every Z-axis position of the object table, the printing head is controlled to print out all dots in that plane on the object table. Only after all the dots in the X-Y plane are printed, the Z-axis stepping motor will move the object table to the next vertical position (Z-axis position) and the printing head then starts to print for all points in this new X-Y plane again. Note that for each point the color blending apparatus mix the desired color fed by the four color ingredient feeders at the same time.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

It is to be understood that, if any prior art publication is referred to herein, such reference does not constitute an admission that the publication forms a part of the common general knowledge in the art, in Australia or any other country.

In the above embodiments, a color 3D printer using CMYK color model based color blending apparatus are explained. However, one skilled in the art would easily apply the present invention to other color printers using different number of base colors, for example three or five. A typical example will be a 3D printer designed for an RGB color model.

1. An apparatus for blending colors for a three-dimensional object printer, comprising:
a mixing chamber comprising a mixed ingredient outlet;
a heating device connected to said mixing chamber for heating up said mixing chamber; and
a guiding device comprising a plurality of color ingredient inlets each configured to receive a corresponding color ingredient from among a plurality of color ingredients, said guiding device coupled to said mixing chamber such that said color ingredients are adapted to pass through said guiding device to enter said mixing chamber, said guiding device configured to guide said color ingredients passing through said guiding device such that a vortex of said color ingredients is formed in said mixing chamber.

2. The apparatus of claim 1, wherein each corresponding color ingredient is a thread material, said guiding device further comprising a plurality of channels each channel for passing therethrough a corresponding color ingredient, said channels guiding said color ingredients to form a predetermined angle between at least two of said color ingredients.

3. The apparatus of claim 2, wherein said channels are configured in said guiding device in a way that each said channel forms an acute angle with a longitudinal axis of said mixing chamber.

4. The apparatus of claim 3, wherein said acute angle is in the range of 2° to 10°.

5. The apparatus of claim 3, wherein said acute angle is 5°.

6. The apparatus of claim 2, wherein said mixing chamber further comprises a first cylindrical chamber and a second cylindrical chamber, said first cylindrical chamber having a diameter larger than that of the second cylindrical chamber, wherein said second cylindrical chamber is connected to said mixed ingredient outlet, and said first cylindrical chamber is configured to receive said guided color ingredients from said guiding device.

7. The apparatus of claim 6, wherein said first cylindrical chamber is configured to receive at least a portion of said guiding device.

8. The apparatus of claim 6, wherein said first cylindrical chamber and said second cylindrical chamber are connected by an intermediate portion having a truncated cone shape.

9. The apparatus of claim 1, wherein said mixing chamber and said guiding device are connected by a plurality of fasteners.

10. The apparatus of claim 9, wherein said guiding device further comprises:
a first end face where said plurality of color ingredient inlets are disposed: and
a second end face facing said mixing chamber, wherein said fasteners extending from said first end pass through said guiding device, and exit said second end face to connect to said mixing chamber, thus connecting said guiding device and said mixing chamber together.

11. The apparatus of claim 10, wherein there is at least one spring placed between said mixing device and said second end face of said guiding device.

12. The apparatus of claim 11, wherein there are a plurality of coil springs placed between said mixing device and said second end face of said guiding device, and each coil spring receiving and allowing a corresponding one fastener of said plurality of fasteners to pass therethrough.

13. The apparatus of claim 9, wherein said fasteners are screws.

14. The apparatus of claim 1, wherein said heating device further comprises a thermometer for detecting real-time temperature of said mixing chamber.

15. The apparatus of claim 1, wherein said color ingredients are fusible color filaments.

16. The apparatus of claim 8, wherein said guiding device comprises four color ingredient inlets, each of which corresponding to a color in CMYK color model.

17. The apparatus of claim 1, wherein said heating device controls temperature of said mixing chamber to be in the range of 160° C. to 240° C.

18. The apparatus of claim 17, wherein said heating device controls temperature of said mixing chamber to be 175° C. or 230° C.

19. The apparatus of claim 1, wherein said mixing chamber has an interior volume in the range of 100 mm³ to 300 mm³.

20. The apparatus of claim 1, wherein said mixing chamber has an interior volume of 160 mm³.

21. The apparatus of claim 1, further comprising a nozzle connected to said mixed ingredient outlet by thread connection.

22. The apparatus of claim 1, wherein an inner surface of said mixing chamber is coated with a non-sticking material.

23. The apparatus of claim 22, wherein said non-sticking material is PTFE.
